(19) United States
(12) Patent Application Publication
(10) Pub. No.: US 2024/0327130 A1
(43) Pub. Date: Oct. 3, 2024

(54) CONVEYOR OPERATION FAULT DETECTION BY A POINT OF SALE SYSTEM

(71) Applicant: Toshiba Global Commerce Solutions, Inc., Durham, NC (US)

(72) Inventors: Timothy Crockett, Raleigh, NC (US); Charles Kurtz, Durham, NC (US)

(21) Appl. No.: 18/126,831

(22) Filed: Mar. 27, 2023

(51) Int. Cl. B65G 43/02; G01G 19/414

(52) U.S. Cl. CPC B65G 43/02; G01G 19/414

(57) ABSTRACT

Systems and methods of conveyor operation fault detection by a POS system are provided. In one exemplary embodiment, a method is performed by a POS system having a conveyor apparatus that includes a conveyor belt having a conveying surface, a conveyor motor operable to advance the conveyor belt so that an object placed on the conveying surface is conveyed along a path from a first end to a second end of the conveying surface, and a load sensor disposed in the POS system. The method includes receiving, by the processing circuit, from the load sensor, a load measurement signal that includes a mechanical noise signal associated with operation of the conveyor apparatus while the conveyor motor is activated to advance the conveyor belt so as to determine that the conveyor apparatus is operable or inoperable based on the mechanical noise signal.

### BACKGROUND

Retailers use point of sale (POS) hardware and software systems to streamline checkout operations and to allow retailers to process sales, handle payments, and store transactions for later retrieval. POS systems generally include a number of components including POS terminal station device and POS bagging station device. POS bagging station devices can enable customers or retail staff to bag purchased retail items in shopping bags during checkout at the POS systems. POS terminal station devices can include a computer, a monitor, a cash drawer, a receipt printer, a customer display, a barcode scanner, or a debit/credit card reader. POS systems can also include a conveyor belt, a checkout divider, a weight scale, an integrated credit card processing system, a signature capture device, or a customer pin pad device. While POS systems may include a keyboard and mouse, more and more POS monitors use touchscreen technology. The POS software can be configured to handle a myriad of customer based functions such as sales, returns, exchanges, layaways, gift cards, gift registries, customer loyalty programs, promotions, and discounts. In a retail environment, there can be multiple POS systems in communication with a server over a network.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1A-B illustrate embodiments of a POS system operable to perform conveyor operation fault detection in accordance with various aspects as described herein. FIG. 1C illustrates a conveyor apparatus of the POS system of FIG. 1B in accordance with various aspects as described herein.

FIG. 2 illustrates another embodiment of a POS system in accordance with various aspects as described herein.

FIG. 3 illustrates another embodiment of a POS system in accordance with various aspects as described herein.

FIG. 4A-C illustrate embodiments of a method performed by a POS system of performing conveyor operation fault detection in accordance with various aspects as described herein.

FIG. 5 illustrates another embodiment of a POS system in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

A POS system can include a conveyor apparatus having an conveyer belt such as to weigh items as they are transferred by the conveyor belt towards the checkout scanner. There is a safety issue where the motor driving the conveyor belt may stall causing the conveyor apparatus to be inoperable even while the motor is activated to advance the conveyor belt. Such failures can cause the conveyor motor to overheat or even worse, to cause a fire if the failure is not detected in sufficient time to deactivate (e.g., shut down, shut off) the conveyor motor. In one exemplary embodiment, a POS system can use a load sensor (e.g., weight scale) integrated with the conveyor apparatus to detect that the conveyor apparatus is operable or inoperable and can deactivate the conveyor motor when the conveyor apparatus is detected as being inoperable.

Furthermore, the load sensor (e.g., conveyer scale) is sensitive to a force normal to a certain region of a conveying surface of the conveyor belt associated with the load sensor such as from a weight of an item as the conveyor belt advances that item onto the certain region of the conveying surface. The load sensor is also sensitive to any mechanical noises (e.g., perturbations, vibrations, colored mechanical noise) caused by one or more components of the conveyor apparatus. When the conveyor motor is activated, the load measurement signals sensed by the load sensor include mechanical noise signals associated with the operation of the conveyor apparatus. As such, the POS system can process the mechanical noise signals to determine whether the conveyor apparatus such as the conveyor belt or the conveyor motor is operable or is inoperable and should be shut down for service.

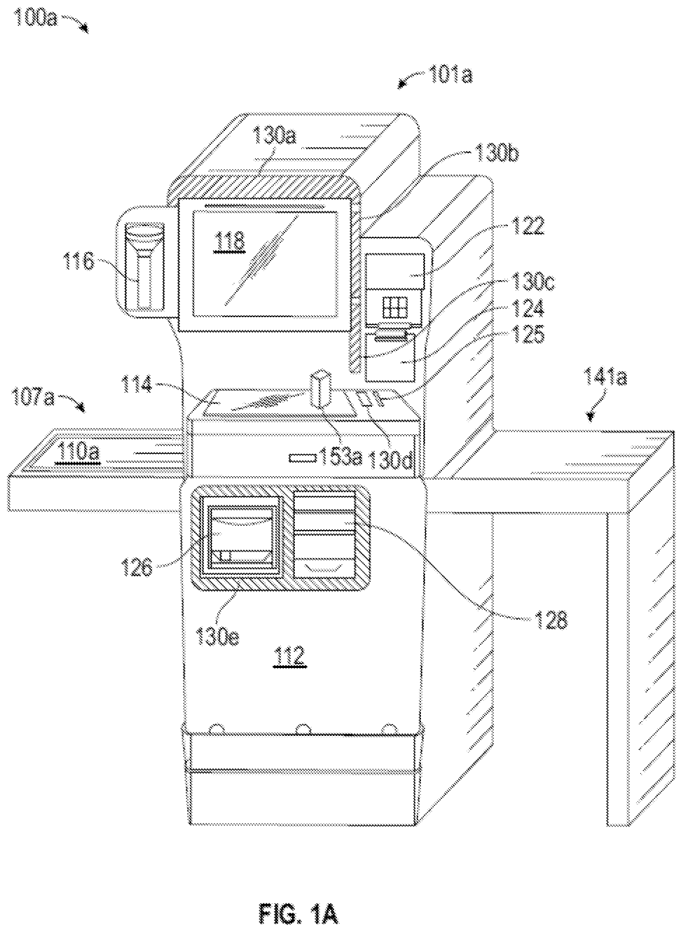

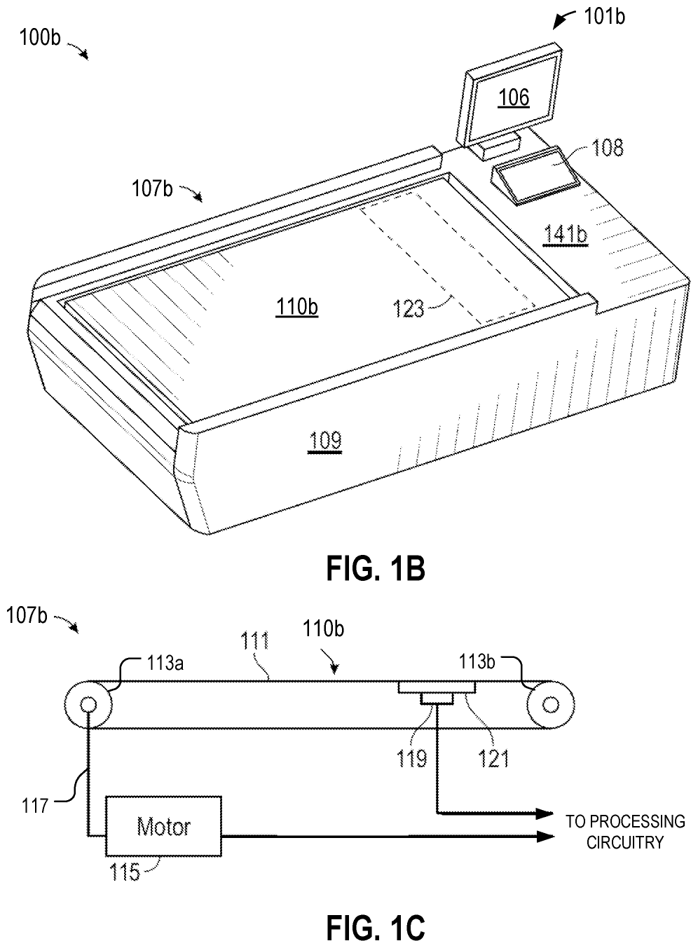

In this disclosure, systems and methods of performing conveyor operation fault detection in a POS system are provided. For example, FIGS. 1A-B illustrate embodiments of a POS system 100a,b operable to perform conveyor operation fault detection with various aspects as described herein. As shown in FIG. 1A, the POS system 100a (e.g., checkout system, self-checkout system) can include a terminal station device 101a, a bagging station device 141a, and a conveyor apparatus 107a that includes a conveyor belt having a conveying surface 110a and a conveyor motor operable to advance the conveyor belt. The terminal station device 101a has a housing 112, one or more optical scanners 114, 116, a display device 118, a payment processing mechanism 122, a printer 124, a coupon slot mechanism 125, a cash acceptor mechanism 126, a change interface mechanism 128, the like, or any combination thereof. In addition, the terminal station device 101a can be configured to include a set of light emitting elements 130a-e (collectively, light emitting elements 130). The housing 112 can be configured to include a cabinet that contains a processing circuit operable to control the operations and functions of the POS system 100a. Each light emitting element 130a-e can be configured to be individually or collectively controlled by a processing circuit of the POS system 100a to indicate certain contextual information to a consumer. Although not explicitly shown herein, the housing 112 can also contain cabling and other functional components that communicatively couple the POS system 100a to a network or a network node device or that communicatively couple the terminal station device 101a to the conveyor apparatus 107a or the bagging station device 141a. A network node device may include, for example, one or more server devices that may or may not be located in the retail store.

In FIG. 1A, each scanner 114, 116 can be configured as an optical scanner operable to scan a bar code displayed on retail items that a consumer intends to purchase. In one example, the scanner 116 can be configured as a hand-held, battery-operated scanner that the consumer removes from its battery charging dock to scan retail items without having to remove them from a shopping cart. For those situations where a retail item does not have a bar code, the scanner 114 can be operable to perform dual scanner and load sensor (e.g., weight sensor, force sensor) functions to allow a retail item 153a to be contemporaneously scanned and weighed for purchase by a consumer. The display 118 can be operable to display information associated with retail items being purchased by a consumer. The payment processing mechanism 122 can be configured with a pinpad device operable to accept a non-cash payment vehicle (e.g., credit card or debit card), while the printer 124 can be configured to print receipts or coupons. The coupon slot mechanism 125 can include a generally elongated slot configured to receive coupons being redeemed by a consumer. The cash acceptor mechanism 126 can be operable to receive cash (e.g., paper money, coins) from the consumer for the retail items being purchased by the consumer. The change interface mechanism 128 can be operable to provide change to the consumer in the form of paper money or coins.

In operation, the processing circuitry of the POS system 101a can activate (e.g., drive, control) the conveyor motor to advance the conveyor belt. The processing circuitry can receive, from the load sensor (e.g., weight sensor, force sensor) disposed with the scanner 114, a load measurement signal that includes a mechanical noise signal that represents the mechanical noise due to the operation of the conveyor apparatus 107a. The processing circuitry processes the load measurement signal to obtain the mechanical noise signal. The processing circuitry may process the load measurement signal by filtering, by a filter, the load measurement signal to obtain the mechanical noise signal. In one example, the filter may include a low pass filter circuit operable to suppress frequency components above a certain frequency (e.g., <60 Hz, >60 Hz). In another example, the filter may include a notch filter operable to suppress frequency components outside a primary frequency component (e.g., <60 Hz, >60 Hz) of the mechanical noise signal. In yet another example, the filter may include a high pass filter operable to suppress frequency components below a certain frequency (e.g., <1 Hz, <5 Hz, <10 Hz). In yet another example, the filter may include a bandpass filter operable to suppress frequency components outside primary and secondary frequency components of the mechanical noise signal. Each of the primary and secondary frequency components may be less than sixty hertz (<60 Hz) in one embodiment, or greater than sixty hertz (>60 Hz) in another embodiment.

The processing circuitry can then determine whether the conveyor apparatus 107a is operable or inoperable based on the mechanical noise signal. In response to determining that the conveyor apparatus 107a is inoperable (e.g., the conveyor belt is not advancing, the motor is not running), the processing circuit can deactivate (e.g., shut down, shut off) the conveyor motor. In addition, the processing circuit, can output, for display on display 118 or one or more light emitting elements 130a-e, a visual representation that indicates that the conveyor apparatus 107a is inoperable. Additionally or alternatively, the processing circuitry can obtain a text or email that indicates that the conveyor apparatus is inoperable and then can send the text or email to a predetermined phone number or email address so as to provide notification of the conveyor apparatus being inoperable.

In FIG. 1B, the POS system 100b (e.g., checkout device, self-checkout device) can include a terminal station device 101b, a bagging station device 141b, a housing 109, and a conveyor apparatus 107b. As shown in FIG. 1C, the conveyor apparatus 107b includes a conveyor belt 111 disposed about opposing spindles 113a,b having a conveying surface 110b and a conveyor motor 115 operable to advance the conveyor belt 111 about the opposing spindles 113a,b via a pulley 117. The terminal station device 101b can include a barcode scanner, a scale, a keyboard 108, keypad, touchscreen 106, card reader, the like, or any combination thereof. The conveyor apparatus 107b can be disposed between the housing 109 such that the conveying surface 110b of the conveyor belt 111 is configured to transfer items along a path from a first end to a second end of the conveying surface 110b associated with the terminal station device 101b. In one example, the conveyor apparatus 107b is operable to advance the conveyor belt 111 continuously via the conveyor motor 115. In another example, the conveyor apparatus 107b is operable to initiate advancement of the conveyor belt 111 via the conveyor motor 115 when a sensor (e.g., presence, proximity or motion sensor) detects a customer approaching the POS system 100b. In yet another example, the conveyor apparatus 107b is operable to initiate movement of the conveyor belt 111 when a sensor (e.g., load sensor) detects any weight placed on the conveying surface 110b of the conveyor belt 111 such as from a retail item. In yet another example, the conveyor apparatus 107b is operable to initiate the advancement of the conveyor belt 111 when a sensor (e.g., presence, proximity or motion sensor) detects an object placed on the conveying surface 110b of the conveyor belt 111.

In the current embodiment, the conveyor apparatus 107b can include a load sensor 119 disposed below a certain region 123 of the conveying surface 110b of the conveyor belt 111 at a position that enables the load sensor 119 to measure a force applied normal to the certain region 123 of the conveying surface 110b such as caused by an object conveyed by the conveyor belt 111 into that certain region 123 of the conveying surface 110b. Further, the load sensor 119 is operable to measure any mechanical noise produced by the conveyor apparatus 107b such as by the conveyor motor 115, the conveyor belt 111, the spindles 113a-b, the pulley 117, or the like. The conveyor apparatus 107b can also include a load receiver plate 121 disposed between the conveyor belt 111 at the certain region 123 of the conveying surface 110b and the load sensor 119. The load receiver plate 121 is operable to transfer any force applied normal to the load receiver plate 121 to the load sensor 119. The surface area of the load receiver plate 121 can correspond to the certain region 123 of the conveying surface 110b of the conveyor belt 111. Further, the load receiver plate 121 is operable to mechanically transfer any mechanical noise produced by the conveyor apparatus 107b to the load sensor 119.

In operation, the processing circuitry of the POS system 101a can activate (e.g., drive, control) the conveyor motor to advance the conveyor belt 111. The processing circuitry can receive, from the load sensor 119 (e.g., weight sensor, force sensor), a load measurement signal that includes a mechanical noise signal associated with operation of the conveyor apparatus 107b. The processing circuitry processes the load measurement signal to obtain a signal that represents the mechanical noise due to the operation of the conveyor apparatus 107b. The processing circuitry may process the load measurement signal by filtering, by a filter, the load measurement signal to obtain the mechanical noise signal. The processing circuitry can then determine whether the conveyor apparatus 107b is operable or inoperable based on the mechanical noise signal. In response to determining that the conveyor apparatus 107b is inoperable (e.g., the conveyor belt 111 is not advancing, the conveyor motor 115 is not running), the processing circuit can deactivate (e.g., shut down, shut off) the conveyor motor 115. In addition, the processing circuit, can output, for display on display 106 or a light emitting element, a visual representation that indicates that the conveyor apparatus 107b,c is inoperable.

In another embodiment, the processing circuitry can process the load measurement signal to obtain the mechanical noise signal. The processing circuitry can then extract a property of the mechanical noise signal. The property can be represented by a time-domain waveform, a frequency domain spectrum plot, a time-frequency spectrogram, the like, or any combination thereof. In one example, the property is a time representation (e.g., amplitude envelope waveform, short-time energy waveform, root mean square energy waveform, zero-crossing rate) of the mechanical noise signal. In another example, the property is a frequency representation (e.g., mean or average frequency, median frequency, signal-to-noise ratio, band energy ratio) of the mechanical noise signal. The processing circuitry can verify that the conveyor apparatus 107a,b is operable based on the mechanical noise signal or the extracted property. The processing circuitry can then send, to neural network circuitry, the extracted property so that the neural network circuitry is enabled to further train the neural network circuitry on the extracted property when the conveyor apparatus 107a,b is operable.

In another embodiment, the processing circuitry can process the load measurement signal to obtain the signal that represents mechanical noise associated with the operation of the conveyor apparatus 107a,b. The processing circuitry can extract the property of the mechanical noise signal. The processing circuitry can then send, to the neural network circuitry, the extracted property of the mechanical noise signal. The neural network circuitry can be trained with the extracted property from those mechanical noise signals received when the conveyor apparatus 107a,b is operable. The processing circuit can receive, from the neural network circuitry, an indication of whether the mechanical noise signal corresponds to a mechanical noise signal received when the conveyor apparatus 107a,b is operable and a confidence level of that indication. In addition, the processing circuitry can determine that the conveyor apparatus 107a,b is operable or inoperable based on the indication and the confidence level of that indication. For instance, the processing circuitry can determine that the conveyor apparatus 107a,b is operable or inoperable based on the indication having a confidence level of at least seventy-five percent (75%) in one embodiment, at least ninety percent (90%) in another embodiment, or at least ninety-five percent (95%) in another embodiment.

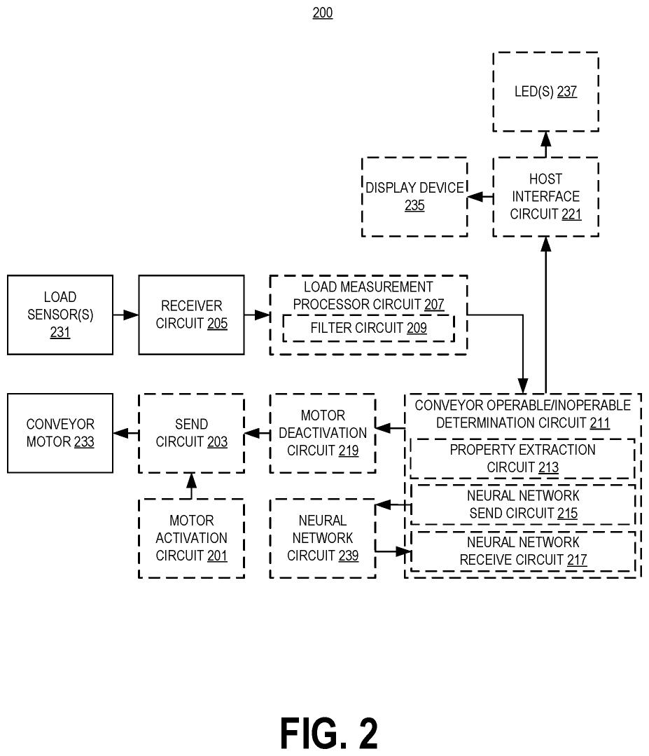

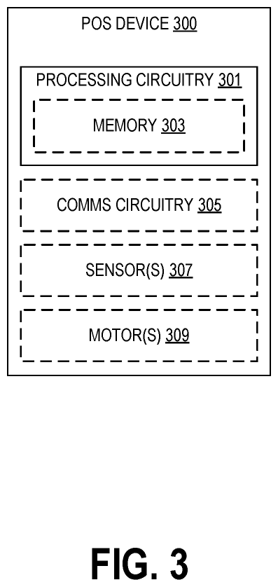

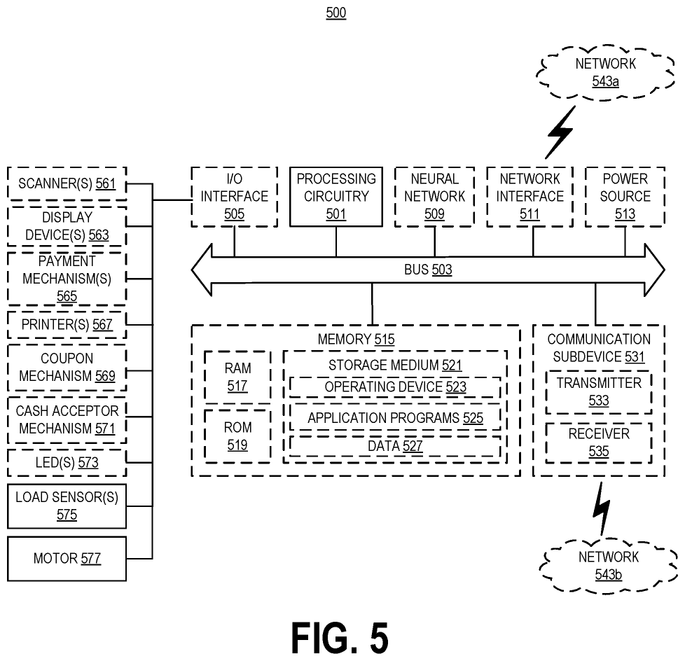

FIG. 2 illustrates one embodiment of a POS system 200 in accordance with various aspects as described herein. In FIG. 2, the device 200 implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: a motor activation circuit 201 operable to activate a motor; a send circuit 203 operable to send information such as to a motor 233; a receiver circuit 205 operable to receive information such as from a load sensor 231; a load measurement processing circuit 207 operable to process a load measurement to obtain a mechanical noise signal; a filter circuit 209 operable to filter a load measurement signal to obtain a mechanical noise signal; a conveyor operable/inoperable determination circuit 211 operable to determine whether a conveyor apparatus is operable or inoperable; a property extraction circuit 213 operable to extract a property of a mechanical noise signal; a neural network send circuit 215 operable to send information to a neural network circuit 239 such as the extracted property of a mechanical noise signal; a neural network receive circuit 217 operable to receive information from the neural network circuit 239 such as an indication of whether an extracted property of a mechanical noise signal corresponds to an operable or inoperable conveyor apparatus; a motor deactivation circuit 219 operable to deactivate a motor; and a host interface circuit 221 operable to interface to input, output, or input/output components such as a display device 235 or an LED 237.

FIG. 3 illustrates another embodiment of a POS system 300 in accordance with various aspects as described herein. In FIG. 3, the device 300 may include processing circuitry 301 that is operably coupled to one or more of the following: memory 303, network communications circuitry 305, one or more sensors 307 (e.g., load sensor), one or more motors 309 (e.g., conveyor motor), the like, or any combination thereof. The network communication circuitry 305 is configured to transmit or receive information to or from one or more other devices via any communication technology. The processing circuitry 301 is configured to perform processing described herein, such as by executing instructions stored in memory 303. The processing circuitry 301 in this regard may implement certain functional means, units, or modules.

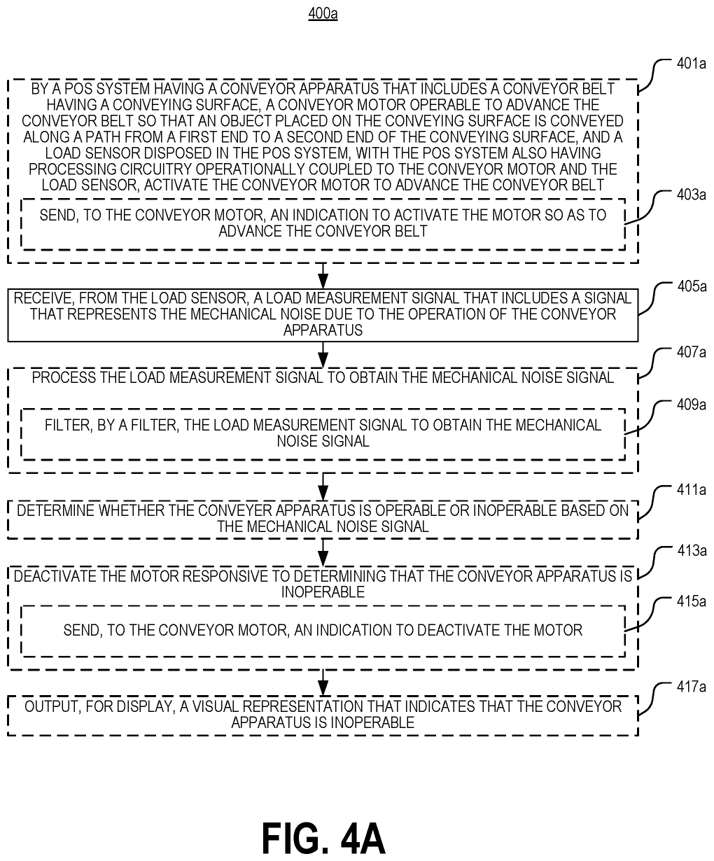

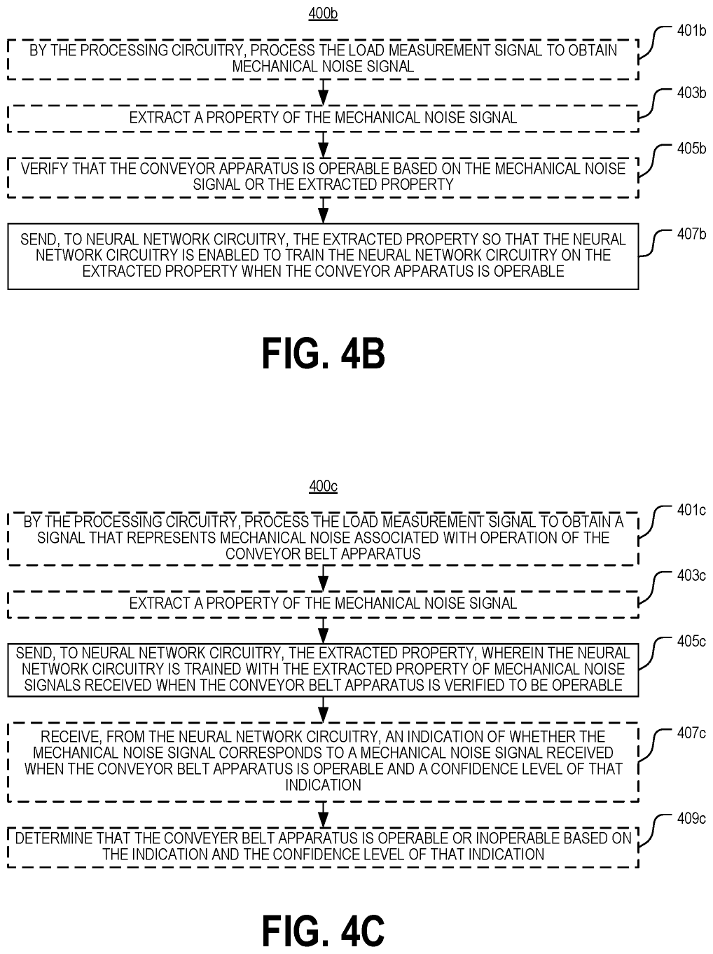

FIG. 4A illustrates one embodiment of a method 400a performed by the POS system 100a-b, 200, 300, 500 of performing conveyor operation fault detection in accordance with various aspects as described herein. In FIG. 4A, the method 400a may start, for instance, at block 401a where it may include activating the conveyor motor to advance the conveyor belt. This motor activation step may include the method 400a sending, to the conveyor motor, an indication to activate the conveyor motor so as to advance the conveyor belt, as represented by block 403a. At block 405a, the method 400a includes receiving, from the load sensor, a load measurement signal that includes a mechanical noise signal associated with operation of the conveyor apparatus. At block 407a, the method 400a may include processing the load measurement signal to obtain the mechanical noise signal. This processing step may include the method 400a filtering, by a filter, the load measurement signal to obtain the mechanical noise signal, as represented by block 409a. At block 411a, the method 400a may include determining whether the conveyor apparatus is operable or inoperable based on the mechanical noise signal. At block 413a, the method 400a may include deactivating the conveyor motor responsive to determining that the conveyor apparatus is inoperable. This deactivating step may include the method 400a sending, to the conveyor motor, an indication to deactivate the conveyor motor, as represented by block 415a. At block 417a, the method 400a may include outputting, for display such as on a display device of the POS system 100a-b, 200, 300, 500, a visual representation that indicates that the conveyor apparatus is inoperable.

FIG. 4B illustrates another embodiment of a method 400b performed by the POS system 100a-b, 200, 300, 500 of performing conveyor operation fault detection in accordance with various aspects as described herein. In FIG. 4B, the method 400b may start, for instance, at block 401b where it may include processing the load measurements signal to obtain the mechanical noise signal. At block 403b, the method 400b may include extracting a property of the mechanical noise signal. At block 405b, the method 400b may include verifying that the conveyor apparatus is operable based on the mechanical noise signal or the extracted property. In response, the method 400b includes sending, to neural network circuitry, the extracted property so that the neural network circuitry is enabled to train the neural network circuitry on the extracted property when the conveyor apparatus is operable.

FIG. 4C illustrates another embodiment of a method 400c performed by the POS system 100a-b, 200, 300, 500 of performing conveyor operation fault detection in accordance with various aspects as described herein. In FIG. 4C, the method 400c may start, for instance, at block 401c where it may include processing the load measurement signal to obtain the mechanical noise signal. At block 403c, the method 400c may extract a property of the mechanical noise signal. At block 405c, the method 400c sends, to the neural network circuitry that is trained with the extracted property of mechanical noise signals received when the conveyor belt apparatus is verified to be operable, the extracted property. At block 407c, the method 400c may include receiving, from the neural network circuitry, an indication of whether the mechanical noise signal corresponds to a mechanical noise signal received when the conveyor belt apparatus is operable and a confidence level of that indication.

FIG. 5 illustrates another embodiment of a POS system or device 500 in accordance with various aspects as described herein. In FIG. 5, device 500 includes processing circuitry 501 that is operatively coupled over bus 503 to input/output interface 505, neural network circuitry 509, network connection interface 511, power source 513, memory 515 including random access memory (RAM) 517, read-only memory (ROM) 519 and storage medium 521, communication subsystem 531, and/or any other component, or any combination thereof.

The input/output interface 505 may be configured to provide a communication interface to an input device, output device, or input and output device. The device 500 may be configured to use an output device via input/output interface 505. An output device 561 may use the same type of interface port as an input device. For example, a USB port or a Bluetooth port may be used to provide input to and output from the device 500. The output device may be a speaker, a sound card, a video card, a display, a monitor, a printer, an actuator, a motor 577 or motor controller, a transducer, an emitter, a smartcard, another output device, or any combination thereof. The device 500 may be configured to use an input device via input/output interface 505 to allow a user to capture information into the device 500. The input device may include a touch-sensitive or presence-sensitive display, an optical sensor, (e.g., a digital camera, a digital video camera, a web camera, etc.), a microphone, a sensor 575 (e.g., load sensor), a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, a microphone, an ultrasound sensor, a load sensor, another like sensor, or any combination thereof. As shown in FIG. 500, the input/output interface 505 can be configured to provide a communication interface to components of the terminal station device 101a such as the scanners 114, 116, the display device 118, the payment processing mechanism 122, the printer 124, the coupon slot mechanism 125, the cash acceptor mechanism 126, light emitting devices 130, the like, or any combination thereof. Further, the input/output interface 505 can be configured to provide a communication interface to components of the terminal station device 101b such as a barcode scanner, a scale, keyboard 108, keypad, touchscreen 107, card reader, the like, or any combination thereof.

In FIG. 5, storage medium 521 may include operating system 523, application program 525, data 527, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the neural network circuit 509 may be configured to learn to perform tasks by considering examples such as performing detection, classification or identification of a mechanical noise signal. In one example, the neural network circuitry 509 is configured to perform identification of a mechanical noise signal as described herein. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a POS system having a conveyor apparatus that includes a conveyor belt having a conveying surface, a conveyor motor operable to advance the conveyor belt so that an object placed on the conveying surface is conveyed along a path from a first end to a second end of the conveying surface, and a load sensor disposed in the POS system. Further, the POS system includes processing circuitry operationally coupled to the conveyor motor and the load sensor. The method includes receiving, by the processing circuit, from the load sensor, a load measurement signal that includes a mechanical noise signal associated with operation of the conveyor apparatus while the conveyor motor is activated to advance the conveyor belt so as to determine that the conveyor apparatus is operable or inoperable based on the mechanical noise signal.

In another exemplary embodiment, the method further includes determining that the conveyor apparatus is inoperable based on the mechanical noise signal.

In another exemplary embodiment, the method further includes deactivating the conveyor motor responsive to determining that the conveyor apparatus is inoperable.

In another exemplary embodiment, the method further includes outputting, for display, a visual representation that indicates that the conveyor apparatus is inoperable.

In another exemplary embodiment, the method further includes obtaining an email or text message that indicates that the conveyor apparatus is inoperable, and sending the email or text message.

In another exemplary embodiment, the method further includes processing the load measurement signal to obtain the mechanical noise signal associated with the operation of the conveyor apparatus.

In another exemplary embodiment, the processing step further includes filtering, by a filter, the load measurement signal to obtain the mechanical noise signal.

In another exemplary embodiment, the filter includes a low pass filter operable to suppress frequency components above a certain frequency.

In another exemplary embodiment, the certain frequency is less than sixty hertz (60 Hz).

In another exemplary embodiment, the filter includes a notch filter operable to suppress frequency components outside a primary frequency component of the mechanical noise signal.

In another exemplary embodiment, the primary frequency component is less than sixty hertz (60 Hz).

In another exemplary embodiment, the filter includes a bandpass filter operable to suppress frequency components outside primary and secondary frequency components of the mechanical noise signal.

In another exemplary embodiment, each of the primary and secondary frequency components is less than sixty hertz (60 Hz).

In another exemplary embodiment, the load sensor is disposed below the conveying surface of the conveyor belt at a position that enables the load sensor to measure a force applied normal to a certain region of the conveying surface such as caused by an object conveyed into that certain region. Further, the load measurement signal includes a signal associated with a force applied normal to the certain region of the conveying surface while the conveyor motor is activated to advance the conveyor belt.

In another exemplary embodiment, the load sensor is disposed with a scanner of the POS system to perform dual scanner and scale functions to enable an object positioned on a surface of the scanner scale to be contemporaneously scanned and weighed. Further, the load sensor is operable to measure a force applied normal to the surface of the scanner scale such as caused by an object positioned on that surface.

In another exemplary embodiment, the method further includes processing the load measurement signal to obtain the mechanical noise signal. The method also includes extracting a property of the mechanical noise signal. The method further includes verifying that the conveyor apparatus is operable based on the mechanical noise signal or the extracted property. In addition, the method includes sending, to neural network circuitry, the extracted property of the mechanical noise signal so that the neural network is enabled to further train the neural network on the extracted property when the conveyor belt is verified to be operable.

In another exemplary embodiment, the method further includes processing the load measurement signal to obtain the mechanical noise signal. The method also includes extracting a property of the mechanical noise signal. In addition, the method includes sending, to neural network circuitry, the extracted property. The neural network circuitry is trained with the extracted property of mechanical noise signals received when the conveyor apparatus is verified to be operable. The method further includes receiving, from the neural network circuitry, an indication of whether the mechanical noise signal corresponds to a mechanical noise signal when the conveyor belt structure is operable and a confidence level of that indication. The method also includes determining that the conveyor apparatus is operable or inoperable based on the indication and the confidence level of that indication.

In one exemplary embodiment, a POS system has a conveyor apparatus that includes a conveyor belt having a conveying surface, a conveyor motor operable to advance the conveyor belt so that an object placed on the conveying surface is conveyed along a path from a first end to a second end of the conveying surface, and a load sensor disposed in the POS system. The POS system also has processing circuitry operationally coupled to the conveyor motor and the load sensor. Further, the POS system includes a memory containing instructions executable by the processing circuitry whereby the processing circuitry is configured to receive, from the load sensor, a load measurement signal that includes a mechanical noise signal associated with operation of the conveyor apparatus while the conveyor motor is activated to advance the conveyor belt so as to determine that the conveyor apparatus is inoperable based on the mechanical noise signal.

In another exemplary embodiment, the memory includes further instructions executable by the processing circuitry whereby the processing circuitry is configured to activate the conveyor motor to advance the conveyor belt; process the load measurement signal to obtain the mechanical noise signal; and deactivate the conveyor motor responsive to determining that the conveyor apparatus is inoperable based on the mechanical noise signal.

In another exemplary embodiment, the load sensor is disposed below the conveying surface of the conveyor belt at a position that enables the load sensor to measure a force applied normal to a certain region of the conveying surface such as caused by an object conveyed into that certain region. Further, the load measurement signal includes a signal associated with a force applied normal to the certain region of the conveying surface while the conveyor motor is activated to advance the conveyor belt.

In another exemplary embodiment, the load sensor is disposed with a scanner of the POS system to perform dual scanner and scale functions to enable an object positioned on a surface of the scanner scale to be contemporaneously scanned and weighed. Further, the load sensor is operable to measure a force applied normal to the surface of the scanner scale such as caused by an object positioned on that surface.

In another exemplary embodiment, the memory includes further instructions executable by the processing circuitry whereby the processing circuitry is configured to: process the load measurement signal to obtain the mechanical noise signal; extract a property of the mechanical noise signal; verify that the conveyor apparatus is operable based on the mechanical noise signal or the extracted property; and send, to neural network circuitry, the extracted property of the mechanical noise signal so that the neural network circuitry is enabled to further train the neural network circuitry on the extracted property when the conveyor belt is verified to be operable.

In another exemplary embodiment, the memory includes further instructions executable by the processing circuitry whereby the processing circuitry is configured to: process the load measurement signal to obtain the mechanical noise signal; extract a property of the mechanical noise signal; send, to neural network circuitry, the extracted property, wherein the neural network circuitry is trained with the extracted property of mechanical noise signals received when the conveyor apparatus is verified to be operable; receive, from the neural network circuitry, an indication of whether the mechanical noise signal corresponds to a mechanical noise signal when the conveyor belt structure is operable and a confidence level of that indication; and determine that the conveyor apparatus is operable or inoperable based on the indication and the confidence level of that indication.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a point of sale (POS) system having a conveyor apparatus that includes a conveyor belt having a conveying surface, a conveyor motor operable to advance the conveyor belt so that an object placed on the conveying surface is conveyed along a path from a first end to a second end of the conveying surface, and a load sensor disposed in the POS system and operable to measure a load, with the POS system also having processing circuitry operationally coupled to the conveyor motor and the load sensor,
receiving, by the processing circuitry, from the load sensor, a load measurement signal that includes a mechanical noise signal associated with operation of the conveyor apparatus while the conveyor motor is activated to advance the conveyor belt so as to determine that the conveyor apparatus is operable or inoperable based on the mechanical noise signal.

2. The method of claim 1, further comprising:
determining that the conveyor apparatus is inoperable based on the mechanical noise signal.

3. The method of claim 1, further comprising:
deactivating the conveyor motor responsive to determining that the conveyor apparatus is inoperable.

4. The method of claim 2, further comprising:
outputting, for display, a visual representation that indicates that the conveyor apparatus is inoperable.

5. The method of claim 2, further comprising:
obtaining an email or text message that indicates that the conveyor apparatus is inoperable; and
sending the email or text message to a predetermined email address or a predetermined phone number.

6. The method of claim 1, further comprising:
processing the load measurement signal to obtain the mechanical noise signal associated with the operation of the conveyor apparatus.

7. The method of claim 6, wherein the processing step further includes:
filtering, by a filter, the load measurement signal to obtain the mechanical noise signal.

8. The method of claim 7, wherein the filter includes a low pass filter operable to suppress frequency components above a certain frequency.

9. The method of claim 7, wherein the filter includes a notch filter operable to suppress frequency components outside a primary frequency component of the mechanical noise signal.

10. The method of claim 7, wherein the filter includes a bandpass filter operable to suppress frequency components outside primary and secondary frequency components of the mechanical noise signal.

11. The method of claim 1, wherein the load sensor is disposed below a certain region of the conveying surface of the conveyor belt at a position that enables the load sensor to measure a force applied normal to the certain region of the conveying surface such as caused by an object conveyed into that certain region; and
wherein the load measurement signal includes a signal associated with a force applied normal to the certain region of the conveying surface while the conveyor motor is activated to advance the conveyor belt.

12. The method of claim 1, wherein the load sensor is disposed with a scanner of the POS system to perform dual scanner and scale functions to enable an object positioned on a surface of the scanner scale to be contemporaneously scanned and weighed, with the load sensor being operable to measure a force applied normal to the surface of the scanner scale such as caused by an object positioned on that surface.

13. The method of claim 1, further comprising:
processing the load measurement signal to obtain the mechanical noise signal;
verifying that the conveyor apparatus is operable based on the mechanical noise signal;
extracting a property of the mechanical noise signal; and
sending, to neural network circuitry, the extracted property of the mechanical noise signal so that the neural network is enabled to further train the neural network on the extracted property when the conveyor belt is verified to be operable.

14. The method of claim 1, further comprising:
processing the load measurement signal to obtain the mechanical noise signal;
extracting a property of the mechanical noise signal;
sending, to neural network circuitry, the extracted property, wherein the neural network circuitry is trained with the extracted property of mechanical noise signals received when the conveyor apparatus is verified to be operable;
receiving, from the neural network circuitry, an indication of whether the mechanical noise signal corresponds to a mechanical noise signal received when the conveyor belt structure is verified to be operable and a confidence level of that indication; and
determining that the conveyor apparatus is operable or inoperable based on the indication and the confidence level of that indication.

15. A point of service (POS) system, comprising:
with the POS system having a conveyor apparatus that includes a conveyor belt having a conveying surface, a conveyor motor operable to advance the conveyor belt so that an object placed on the conveying surface is conveyed along a path from a first end to a second end of the conveying surface, and a load sensor disposed in the POS system and operable to measure a load, with the POS system also having processing circuitry operationally coupled to the conveyor motor and the load sensor,
wherein the POS system further includes a memory, the memory containing instructions executable by the processing circuitry whereby the processing circuitry is configured to:
receive, from the load sensor, a load measurement signal that includes a mechanical noise signal associated with operation of the conveyor apparatus while the conveyor motor is activated to advance the conveyor belt so as to determine that the conveyor apparatus is operable or inoperable based on the mechanical noise signal.

16. The POS system of claim 15, wherein the memory includes further instructions executable by the processing circuitry whereby the processing circuitry is configured to:
activate the conveyor motor to advance the conveyor belt;
process the load measurement signal to obtain the mechanical noise signal; and
deactivate the conveyor motor responsive to determining that the conveyor apparatus is inoperable based on the mechanical noise signal.

17. The POS system of claim 15, wherein the load sensor is disposed below the conveying surface of the conveyor belt at a position that enables the load sensor to measure a force applied normal to a certain region of the conveying surface such as caused by an object conveyed into that certain region; and
wherein the load measurement signal includes a signal associated with a force applied normal to the certain region of the conveying surface while the conveyor motor is activated to advance the conveyor belt.

18. The POS system of claim 15, wherein the load sensor is disposed with a scanner of the POS system to perform dual scanner and scale functions to enable an object positioned on a surface of the scanner scale to be contemporaneously scanned and weighed, with the load sensor being operable to measure a force applied normal to the surface of the scanner scale such as caused by an object positioned on that surface.

19. The POS system of claim 15, wherein the memory includes further instructions executable by the processing circuitry whereby the processing circuitry is configured to:
process the load measurement signal to obtain the mechanical noise signal;
extract a property of the mechanical noise signal;
verify that the conveyor apparatus is operable based on the mechanical noise signal or the extracted property; and
send, to neural network circuitry, the extracted property of the mechanical noise signal so that the neural network circuitry is enabled to further train the neural network circuitry on the extracted property when the conveyor belt is verified to be operable.

20. The POS system of claim 15, wherein the memory includes further instructions executable by the processing circuitry whereby the processing circuitry is configured to:
process the load measurement signal to obtain the mechanical noise signal;
extract a property of the mechanical noise signal;
send, to neural network circuitry, the extracted property, wherein the neural network circuitry is trained with the extracted property of mechanical noise signals received when the conveyor apparatus is verified to be operable;
receive, from the neural network circuitry, an indication of whether the mechanical noise signal corresponds to a mechanical noise signal received when the conveyor belt structure is verified to be operable and a confidence level of that indication; and
determine that the conveyor apparatus is operable or inoperable based on the indication and the confidence level of that indication.
